(19) United States
(12) Patent Application Publication
(10) Pub. No.: US 2008/0040688 A1
(43) Pub. Date: Feb. 14, 2008

(54) Method and Apparatus for Displaying Notifications

(76) Inventors: George Hoffman, Campbell, CA (US); Erik Perotti, Santa Cruz, CA (US); Elizabeth Dykstra-Erickson, San Francisco, CA (US)

Correspondence Address: Berry & Associates P.C., Suite 810, 9255 Sunset Boulevard, Los Angeles, CA, 90069, US

(21) Appl. No.: 11/674,037

(22) Filed: Feb. 12, 2007

Related U.S. Application Data
(60) Provisional application No. 60/772,041, filed on Feb. 10, 2006.

(51) Int. Cl. G06F 3/14

(52) U.S. Cl. 715/846

(57) ABSTRACT

A method of presenting telephone functions as interactive elements on a mobile device is disclosed. The method includes the steps of focusing on a call, where the call is selected by user activation from one or more calls occurring on the mobile device. And displaying contextual buttons related to the call, where the contextual buttons are configured for operating on the call.

### CROSS-REFERENCE TO RELATED APPLICATIONS

This application claims the benefit under 35 U.S.C. § 119(e) of U.S. Provisional Patent Application No. 60/772,041 filed on Feb. 10, 2006 entitled “Method and Apparatus for Displaying Notifications,” which is herein incorporated by reference.

### FIELD OF THE INVENTION

The present invention generally relates to method and apparatus for providing notifications to a user and more specifically to a method and apparatus for providing notifications in an entertaining and attention-getting manner.

### BACKGROUND OF THE INVENTION

Existing processing devices typically provide notifications to users by displaying an icon at a particular location of a display screen. In many cases the displayed icon may not indicate a number of notifications. The icon may always have the same appearance and may always appear in the same location.

Users have become accustomed to such notifications. In some cases, users may not notice the notifications due to their appearance in only one location of the display screen and always in the same manner.

What is needed in the art is an improved interface which simplifies and improves the user experience for navigating applications and interacting with a computing device, such as, for example, a small handheld device.

Therefore, there is a need for an improved interface for interacting with the computing device.

These and other advantages may be provided by various embodiments of the present invention.

### SUMMARY OF THE INVENTION

In one embodiment, the present invention provides a method for displaying user notifications on a mobile device, said mobile device having a screen, said method comprising the steps of: displaying a dynamic wallpaper on said screen, said dynamic wallpaper including a grid of random colored blocks; sharpening the shape of said colored blocks; forming sharpened icons from said sharpened shapes when user notifications are equipped.

In another embodiment, the present invention provides a method for providing user notifications on a mobile device, said method comprising the steps of: displaying a grid of random colored blocks; sharpening said blocks to form shapes; determining whether there are any notifications to display; if there are notifications to display, forming a line around the shapes; and if there are notifications to display, extruding notifications from said shapes.

Additional features and advantages of the invention will be set forth in the description which follows, and in part will be obvious from the description, or may be learned by practice of the invention.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 illustrates an exemplary processing device in which implementations consistent with principles of the invention may execute;

FIG. 2 illustrates an implementation of the processing device of FIG. 1 consistent with principles of the invention;

FIGS. 3-10 illustrate exemplary display screens consistent with the principles of the invention; and

FIG. 11 is a flowchart that illustrates exemplary processing in an implementation consistent with the principles of the invention

### DETAILED DESCRIPTION OF ILLUSTRATIVE EMBODIMENTS

In the following description, for purposes of explanation and not limitation, specific details are set forth, such as particular networks, communication systems, computers, terminals, devices, components, techniques, data and network protocols, software products and systems, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, terminals, devices, components, techniques, data and network protocols, software products and systems, operating systems, development interfaces, and hardware are omitted so as not to obscure the description of the present invention.

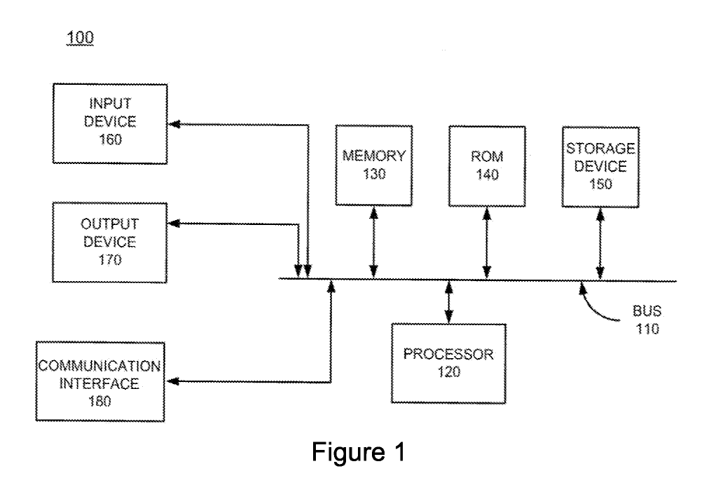

FIG. 1 illustrates a block diagram of an exemplary processing device 100 which may be used to implement systems and methods consistent with the principles of the invention. Processing device 100 may include a bus 110, a processor 120, a memory 130, a read only memory (ROM) 140, a storage device 150, an input device 160, an output device 170, and a communication interface 180. Bus 110 may permit communication among the components of processing device 100.

Processor 120 may include at least one conventional processor or microprocessor that interprets and executes instructions. Memory 130 may be a random access memory (RAM) or another type of dynamic storage device that stores information and instructions for execution by processor 120. Memory 130 may also store temporary variables or other intermediate information used during execution of instructions by processor 120. ROM 140 may include a conventional ROM device or another type of static storage device that stores static information and instructions for processor 120. Storage device 150 may include any type of media, such as, for example, magnetic or optical recording media and its corresponding drive.

Input device 160 may include one or more conventional mechanisms that permit a user to input information to system 200, such as a keyboard, a pen, a voice recognition device, a microphone, a headset, a digitizer, etc. Output device 170 may include one or more conventional mechanisms that output information to the user, including a display, one or more speakers, a headset, or a medium, such as a memory, or a magnetic or optical disk and a corresponding disk drive. Communication interface 180 may include any transceiver-like mechanism that enables processing device 100 to communicate via a network, such as, for example, a computer network or a telephone network. For example, communication interface 180 may include a modem, or an Ethernet interface for communicating via a local area network (LAN). Alternatively, communication interface 180 may include other mechanisms for communicating with other devices and/or systems via wired, wireless or optical connections.

Processing device 100 may perform such functions in response to processor 120 executing sequences of instructions contained in a computer-readable medium, such as, for example, memory 130, a magnetic disk, or an optical disk. Such instructions may be read into memory 130 from another computer-readable medium, such as storage device 150, or from a separate device via communication interface 180.

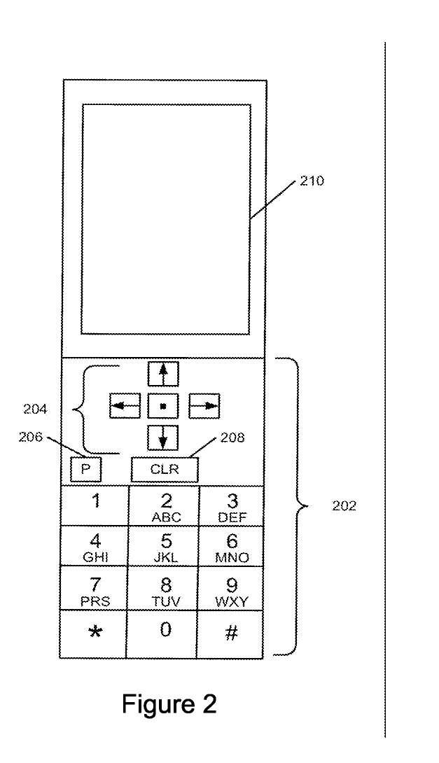

FIG. 2 illustrates an implementation of exemplary processing device 100 consistent with the principles of the invention. Processing device 100 may include a keyboard 202 and a display 210. The keyboard may further include a group of keys representing numbers, letters, and/or symbols, as well as navigation keys 204, a panel key 206, and a clear/exit (CLR) key 208. In one implementation, the navigation keys may include five keys, a center key, right and left keys, and up and down keys.

Exemplary Operation and Displays

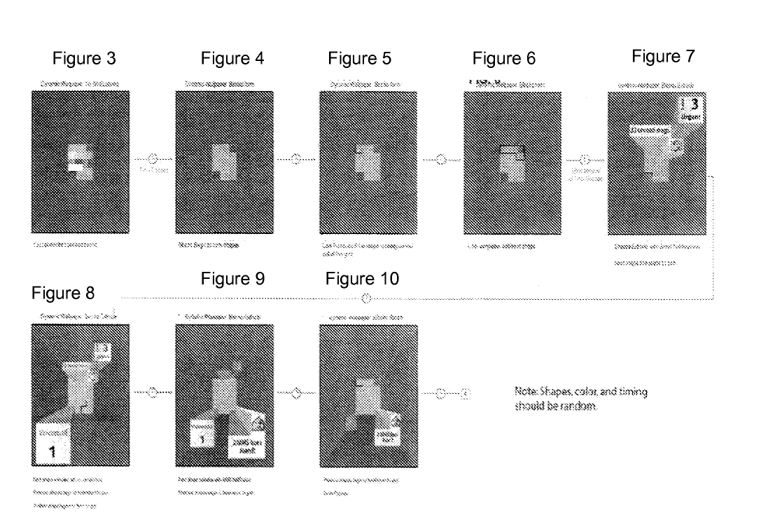

FIG. 3 illustrates an exemplary display including dynamic wallpaper. Dynamic wallpaper includes a grid of random colored blocks that may change over time. After a period of time the colored blocks may begin to form shapes, as can be seen in the exemplary display of FIG. 4. As more time elapses, a line may form as if the shape is being carved out of a grid. FIG. 5 illustrates an exemplary display showing formation of the line. As more time passes, the line may complete an outline of the shape, as can be seen in the exemplary display of FIG. 6.

Eventually, the shapes may appear to extrude from the display, as illustrated in the exemplary display of FIG. 7. FIG. 7 shows a notification extruding from the display indicating that 32 messages are unread, along with an email icon, further indicating that the messages are email messages. In addition, an additional shape may appear to extrude from the display indicating that a number of messages, for example 3 messages are urgent messages. Further, if more notifications exits, then an additional shape may begin to be formed by a line.

As more time passes, the line may complete the shape and the shape may extrude from the display thereby providing another notification. For example, the notification may indicate existence of one or more voicemail messages, as illustrated in FIG. 8. As the new notification forms, the existing notifications may begin to fade and a line may form around another shape if another notification exists.

As more time passes, the line may complete the shape and the shape may extrude from the display thereby providing yet another notification. For example, the notification may indicate existence of one or more multimedia message service (MMS) messages, as illustrated in FIG. 9. FIG. 9 illustrates 2 MMS messages from a user called “Juan P”. As the new notification forms, the existing notifications may begin to fade and a line may form around another shape when another notification exists.

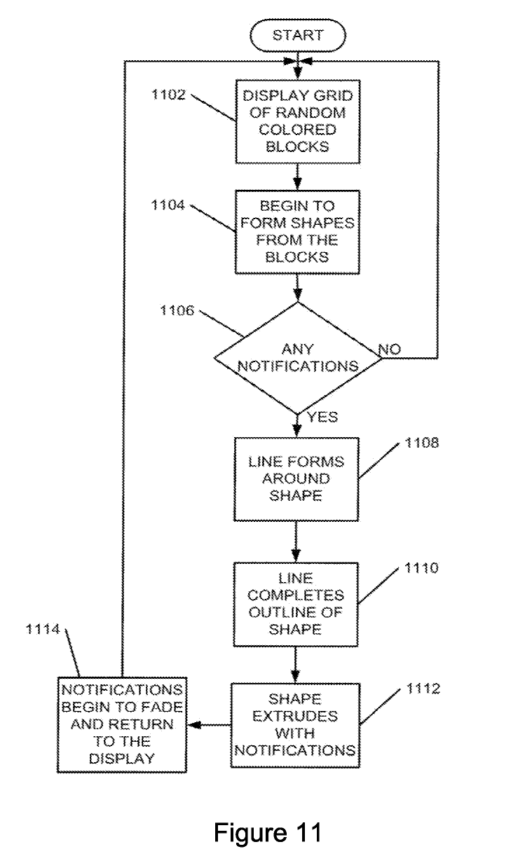

FIG. 11 illustrates an exemplary process that may be performed in implementations consistent with the principles of the invention. First, processing device 100 may display a grid of random colored blocks (act 1102). Colors of the blocks may dynamically change. The blocks may begin to form shapes (act 1104). Processing device 100 may then determine whether there are any notifications to display (act 1106). If there are no notifications, processing device 100 may perform acts 1102 through 1106 again. Otherwise, processing device 100 may show a line forming around the shapes (act 1108). Eventually, the line may complete an outline of the shape (act 1110). Processing device 100 may then display the shape extruding with notifications (act 1112), such as, for example, notifications of voicemail messages, email messages, MMS messages, Short Message Service (SMS) messages or other types of messages, as well as a number of the messages and a priority of the message, such as normal, high, low, urgent, or other priorities. Eventually, the notifications may begin to fade and return to the grid in the display (act 1114). The cycle may then be repeated (acts 1102-1114).

In other implementations, instead of displaying extruding blocks, when a user needs to be informed of a notification, one or more fuzzy words, which may include numbers, may appear on a display screen and may become enlarged and more in focus. Eventually, the words may recede and become less focused before new words may appear on the display screen.

Implementations consistent with the principles of the invention may provide the user with a capability to configure which types of notices he or she is interested in receiving and whether a number of messages should be indicated, as well as a priority of the message.

### CONCLUSION

The above-described embodiments and displays are exemplary and are not limiting with respect to the scope of the invention. Embodiments within the scope of the present invention may include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in networked computing environments with many types of processing system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A method for displaying user notifications on a mobile device, said mobile device having a screen, said method comprising the steps of:
displaying a dynamic wallpaper on said screen, said dynamic wallpaper including a grid of random colored blocks;
sharpening the shape of said colored blocks;
forming sharpened icons from said sharpened shapes when user notifications are equipped.

2. The method in accordance with claim 1 wherein said forming step comprises extruding colored blocks.

3. The method in accordance with claim 1 wherein said icon signifies electronic mail.

4. The method in accordance with claim 1 wherein said icon signifies a short message service (SMS).

5. The method in accordance with claim 1 wherein said notifications includes the priority of the notification.

6. A method for providing user notifications on a mobile device, said method comprising the steps of:
displaying a grid of random colored blocks;
sharpening said blocks to form shapes;
determining whether there are any notifications to display;
if there are notifications to display, forming a line around the shapes; and
if there are notifications to display, extruding notifications from said shapes.

7. The method in accordance with claim 6, wherein said colored blocks change colors dynamically.

8. The method in accordance with claim 6 wherein said forming step comprises extruding colored blocks.

9. The method in accordance with claim 6 wherein said notification signifies electronic mail.

10. The method in accordance with claim 6 wherein said notification signifies a short message service (SMS).

11. The method in accordance with claim 6 wherein said notification includes the priority of the notification.

12. The method in accordance with claim 6 wherein said notification is represented by an icon.
